(19) United States
(12) Patent Application Publication
(10) Pub. No.: US 2004/0102234 A1
(43) Pub. Date: May 27, 2004

(54) Poker-type game and method

(76) Inventor: Steven Terrance Gold, Las Vegas, NV (US)

Correspondence Address: WEISS & MOY PC, 4204 NORTH BROWN AVENUE, SCOTTSDALE, AZ, 85251, US

(21) Appl. No.: 10/303,124

(22) Filed: Nov. 25, 2002

(51) Int. Cl. A63F 9/24; A63F 13/00; G06F 17/00; G06F 19/00

(52) U.S. Cl. 463/13

(57) ABSTRACT

A poker-style game and method in which a player who achieves a predetermined winning hand, preferably a royal flush, is provided with a free bonus hand. In the event that the free bonus hand, which preferably comprises a full playing hand, comprises a predetermined winning combination, a jackpot is paid. Preferably, the jackpot payable for achievement of a predetermined winning combination in the bonus hand is progressive.

### FIELD OF THE INVENTION

This invention relates generally to poker-type games and methods, and more particularly to a poker-type game and method that provides increased jackpot opportunities and thus increased player excitement.

### BACKGROUND OF THE INVENTION

The game of poker is widely played in a casino setting. It is played both in a traditional format, with traditional playing cards, and in an electronic format. In the electronic version, typically known as “video poker,” a player makes a wager and is presented with five cards. A player can choose to discard a specified number of cards and receive replacement cards. Whether or not the player's final hand qualifies for a payment is determined according to a pay table, which is generally displayed on the video poker machine itself.

The best hand that a player can achieve in classic five card poker of the type typically played on video poker machines is a royal flush. A royal flush consists of an Ace-high straight, where all of the cards have the same suit. The payout for a royal flush can be quite significant, and indeed potentially life-altering. Of course, other difficult-to-achieve hands are also possible, including for example four-of-a-kind, a straight flush, etc.

It is desired to create additional jackpot opportunities, after a party has achieved a first jackpot, to increase player excitement and thus player participation. The present game satisfies these needs and provides other, related, advantages.

### SUMMARY OF THE INVENTION

It is an object of the present invention to provide a poker-style game and method that provides a player with a bonus hand and thus an opportunity for an additional jackpot, in the event that the player achieves a predetermined winning hand.

It is a further object of the present invention to provide a poker-style game and method that provides a player with a bonus hand and thus an opportunity for an additional jackpot, in the event that the player achieves a royal flush.

It is a further object of the present invention to provide a progressive jackpot feature for jackpots associated with the bonus hand.

Other objects, features and advantages of the present invention will become apparent from a consideration of the following detailed description.

### BRIEF DESCRIPTION OF THE PREFERRED EMBODIMENTS

In accordance with one embodiment of the present invention, a poker-style game is disclosed. The game comprises, in combination: a video display adapted to display to a player playing cards for a poker-style game; means for permitting a player to hold a desired number of the playing cards; means for permitting the player to receive replacement cards for each of the playing cards that the player elects not to hold; means for providing the player with a free bonus hand following achievement of a predetermined winning combination of the playing cards including any the replacement cards; and means for determining whether the bonus hand entitles the player to receive a payout.

In accordance with another embodiment of the present invention, a method for playing a poker-style game is disclosed. The method comprises the steps of: providing a video display adapted to display to a player playing cards for a poker-style game; displaying the playing cards to the player on the video display; permitting a player to hold a desired number of the playing cards; permitting the player to receive replacement cards for each of the playing cards that the player elects not to hold; the player achieving a predetermined winning combination of the playing cards and any the replacement cards received by the player; and providing the player with a free bonus hand following achievement of the predetermined winning combination; means for determining whether the bonus hand entitles the player to receive a payout.

In accordance with still another embodiment of the present invention, a method for playing a poker-style game is disclosed. The method comprises the steps of: providing a video display adapted to display to a player playing cards for a poker-style game; displaying the playing cards to the player on the video display; permitting a player to hold a desired number of the playing cards; permitting the player to receive replacement cards for each of the playing cards that the player elects not to hold; the player achieving a predetermined winning combination of the playing cards and any the replacement cards received by the player; providing the player with a free bonus hand following achievement of the predetermined winning combination; and means for determining whether the bonus hand entitles the player to receive a payout.

### BRIEF DESCRIPTION OF THE DRAWINGS

FIG. 1 is a front view of a video poker terminal.

FIG. 2 is a flow chart depicting a number of methods of play consistent with the present invention.

FIG. 3 is a flow chart depicting a method of funding of a progressive jackpot feature of a method of play consistent with the present invention.

### DETAILED DESCRIPTION OF THE PREFERRED EMBODIMENTS

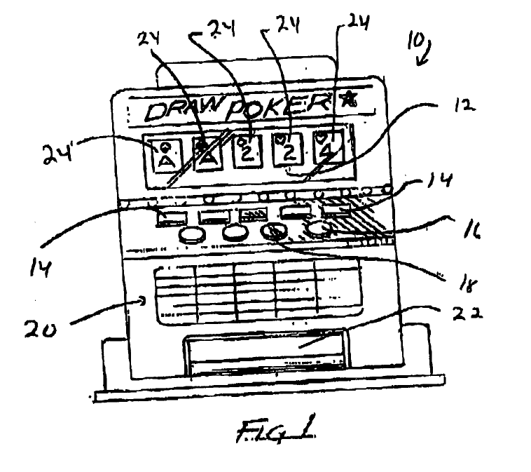

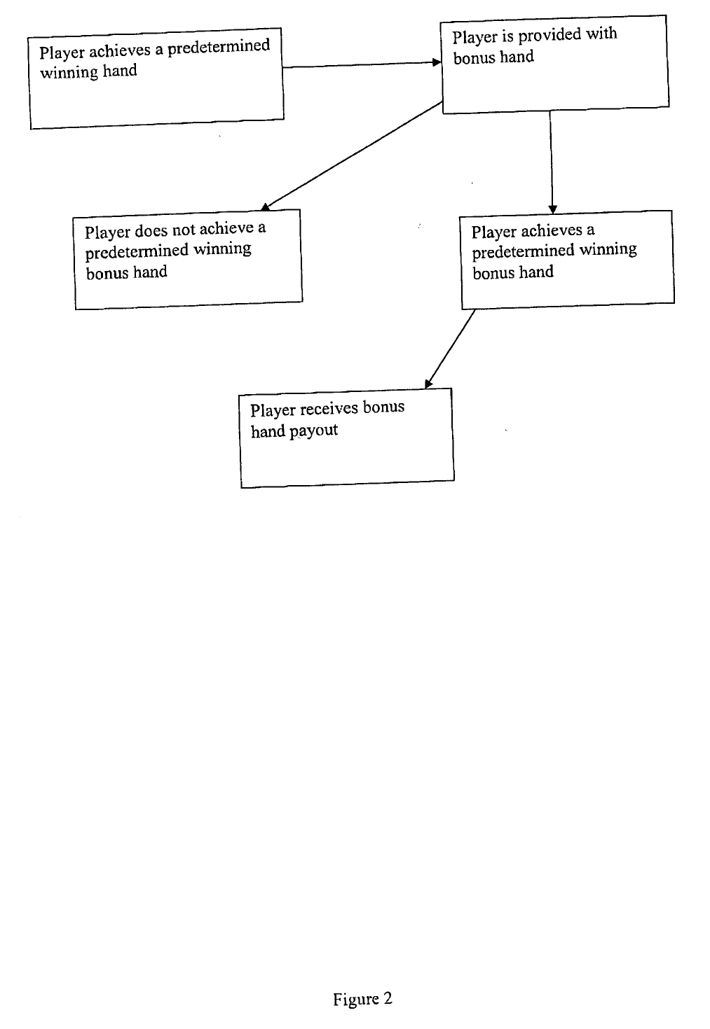

Referring first to FIG. 1, a video poker terminal 10 is shown. Its main features include a video display 12 (see also FIG. 2), five hold buttons 14, a draw/deal button 16, at least one bet button 18, a pay table 20, and a coin output 22. The terminal 10 should also have a payment receiver (not shown), through which coins, cash, payment cards, or the like may be inserted for purposes of placing a wager.

Generally, in a prior art poker game, play is initiated by the insertion of a payment into the payment receiver. A player will typically then depress the bet button 18 in order to receive a display of a hand of cards. (In some games, more than one bet button 18 is provide, with for example one bet button allowing a player to bet one amount, and another allowing a player to bet a larger amount.) After a hand of cards is displayed in the video display 12, the player then decides which he or she wants to hold and which to discard. A player indicates a hold selection for each card that is to be held by depressing the hold button 14 located directly below a card 24 that is to be held. (If a player changes his or her mind, the hold button 14 can be depressed a second time to cancel the selection.)

Once the player completes his or her hold selections, the player will depress the draw/deal button 16 a second time. This will cause the non-held cards 24 to be replaced with new cards. If the player has a winning hand according to the pay table 20, a payment is made through the coin output 22.

The present invention concerns the situation presented when the player achieves a predetermined winning combination of playing cards. Preferably, that predetermined winning combination is a royal flush. Alternatively, the predetermined winning combination could be a more achievable hand, such as four-of-a-kind or a straight flush, though other combinations are certainly possible.

Referring now to FIG. 2, a player who has achieved a predetermined winning combination of playing cards is provided with a bonus hand, for which no additional wager is required. The bonus hand can consist of a single card, a partial hand of two or more cards, or, preferably, a full hand of five cards.

Where the bonus hand represents only a partial hand, the entitlement to a jackpot can depend on the value or identity of the card(s) dealt. Alternatively, the bonus hand could be a single card, followed by a re-shuffling of the deck, and then the provision of a second card, with a payout occurring where the two cards match each other.

Where the bonus hand represents a full hand for the game being played, the entitlement to an additional jackpot would depend on the nature of the hand received. In one embodiment, a pay table would be provided, with jackpot amounts being specified for a range of hands. For example, in this embodiment, jackpot payments could begin for a bonus hand of a pair of jacks, and the payment amounts could increase for progressively better hands.

It should be noted that the bonus hand can be displayed in a frame separate from that displaying the original hand. Moreover, the bonus hand process can be repeating, so that the achievement of a winning bonus hand would trigger the dealing of a second bonus hand. The second bonus hand could be displayed in yet another frame. This process could continue an essentially unlimited number of times, until such time as the player receives a bonus hand that is not a winning hand.

The bonus hand jackpot payment amounts could be fixed or, alternatively, could be progressive in nature. Where they are progressive, the jackpot would be structured to grow from game to game, until won. Where the occurrence of the predetermined winning hand and winning bonus hand would be particularly rare, a progressive jackpot for a jackpot bonus hand would, have the opportunity to grow substantially. In this regard, in a preferred embodiment, a bonus hand would only be received where the player achieved a royal flush, and a bonus jackpot would be pa able only in the event that a player achieved a second royal flush with the bonus hand. Because the occurrence of back-to-back royal flushes would be extremely rare, the amount of the progressive jackpot for a second royal flush could grow over an extended period of time to a point where it could become extremely high, creating player excitement and encouraging player participation.

Where the number of bonus cards dealt is equivalent to a full poker hand, it is possible to provide a game in which the player is not permitted to draw any replacement cards. Alternatively, the player could be provided with the option to draw one or more replacement cards, including even the possibility to replace all of the dealt cards with replacement cards.

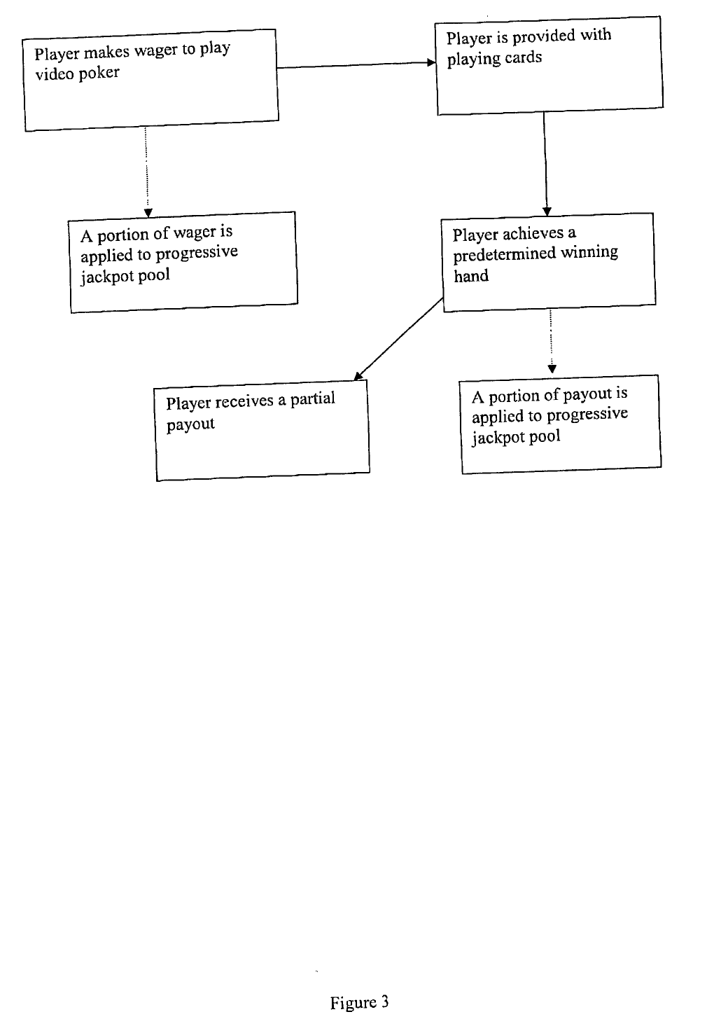

For the funding of a progressive jackpot, several methods are possible. For example, a portion of each amount wagered can be diverted to the progressive jackpot. Or, alternatively, a percentage of certain (or all) jackpots earned during ordinary play on the video poker terminal 10 can be diverted into the progressive jackpot. FIG. 3 illustrates possible progressive jackpot funding alternatives.

It should be recognized that the present invention is directed to any type of poker-type game, including three card poker, five card poker, seven card poker, Caribbean Stud poker, etc.

While the invention has been illustrated with respect to several specific embodiments thereof, these embodiments should be considered as illustrative rather than limiting. Various modifications and additions may be made and will be apparent to those skilled in the art. Accordingly, the invention should not be limited by the foregoing description, but rather should be defined only by the following claims.

I claim:

1. A poker-style game comprising:
a video display adapted to display to a player playing cards for a poker-style game;
means for permitting a player to hold a desired number of said playing cards;
means for permitting said player to receive replacement cards for each of said playing cards that said player elects not to hold;
means for providing said player with a free bonus hand following achievement of a predetermined winning combination of said playing cards including any said replacement cards;
means for determining whether said bonus hand entitles said player to receive a payout.

2. The poker-style game of claim 1 wherein said means for determining whether said bonus hand entitles said player to receive said is adapted to determine whether said bonus hand is equal to or better than a pair of Jacks.

3. The poker-style game of claim 1 wherein an amount of said payout is progressive.

4. A method for playing a poker-style game comprising the steps of:
providing a video display adapted to display to a player playing cards for a poker-style game;
displaying said playing cards to said player on said video display;
permitting a player to hold a desired number of said playing cards;
permitting said player to receive replacement cards for each of said playing cards that said player elects not to hold;
said player achieving a predetermined winning combination of said playing cards and any said replacement cards received by said player;
providing said player with a free bonus hand following achievement of said predetermined winning combination; and
means for determining whether said bonus hand entitles said player to receive a payout.

5. The method of claim 4 wherein said bonus hand comprises a single playing card.

6. The method of claim 4 wherein said bonus hand comprises at least two playing cards.

7. The method of claim 4 wherein said bonus hand comprises a number of playing cards sufficient to play a poker-type game.

8. The method of claim 5 wherein said bonus hand comprises five playing cards.

9. The method of claim 7 further comprising the step of permitting said player to receive replacement cards for at least one of said playing cards comprising said bonus hand.

10. The method of claim 7 further comprising the step of permitting said player to receive, replacement cards for each of said playing cards comprising said bonus hand.

11. The method of claim 4 wherein an amount of said payout is progressive.

12. The method of claim 4 wherein said predetermined winning combination is a royal flush.

13. A method for playing a poker-style game comprising the steps of:
providing a video display adapted to display to a player playing cards for a poker-style game;
displaying said playing cards to said player on said video display;
permitting a player to hold a desired number of said playing cards;
permitting said player to receive replacement cards for each of said playing cards that said player elects not to hold;
said player achieving a predetermined winning combination of said playing cards and any said replacement cards received by said player;
providing said player with a free bonus hand following achievement of said predetermined winning combination; and
means for determining whether said bonus hand entitles said player to receive a payout.

14. The method of claim 13 wherein said bonus hand comprises a single playing card.

15. The method of claim 13 wherein said bonus hand comprises at least two playing cards.

16. The method of claim 13 wherein said bonus hand comprises a number of playing cards sufficient to play a poker-type game.

17. The method of claim 15 wherein said bonus hand comprises five playing cards.

18. The method of claim 16 further comprising the step of permitting said player to receive replacement cards for at least one of said playing cards comprising said bonus hand.

19. The method of claim 16 further comprising the step of permitting said player to receive replacement cards for each of said playing cards comprising said bonus hand.

20. The method of claim 13 wherein an amount of said payout is progressive.
